(19) United States
(12) Patent Application Publication
(10) Pub. No.: US 2006/0082163 A1
(43) Pub. Date: Apr. 20, 2006

(54) Door and drawer locking system

(76) Inventors: Ara Dionysian, Los Angeles, CA (US); Emil Dionysian, Los Angeles, CA (US); Alex Dionysian, Los Angeles, CA (US); Raffi Dionysian, Los Angeles, CA (US)

Correspondence Address: DIONYSIAN ARA, 12550 Allin Street, Los Angeles, CA, 90066-6718, US

(21) Appl. No.: 11/237,565

(22) Filed: Sep. 29, 2005

Related U.S. Application Data
(63) Continuation-in-part of application No. 10/746,771, filed on Dec. 23, 2003, now Pat. No. 6,976,714.
(63) Continuation-in-part of application No. 10/917,607, filed on Aug. 13, 2004, now abandoned.

(51) Int. Cl. E05C 1/12

(52) U.S. Cl. 292/170

(57) ABSTRACT

Provided are exemplary embodiments that may include a cabinet door and drawer securing system, including a sliding wedge, coupled to a coil spring, a shaft coupled to a cam, a knob coupled to the shaft, a clad housing with a cover. With this configuration, when the door be closed by any means, could not be opened, and the drawer if be pushed in could not be pulled out unless an adult rotate the knob, which causes the wedge to be activated and the door opened or the drawer be pulled out.

### CROSS-REFERANCES ON RELATED APPLICATIONS

The patent application is a continuation-in-part of application Ser. No. 10/746,771 filed Dec. 23, 2003, Title Cabinet door system, which is already in publication, and application Ser. No. 10/917,607 filed Aug. 13, 2004, Title; Cabinet door locking system which is incorporated by reference herein its entry for all purposes

### BACKGROUND

Some interior doors may utilize a lock with knob or other similar method to secure the door in the closed position. However, these types of securing configurations may not typically be used for cabinet doors and drawers, like the ones in Kitchen. Such cabinet doors and drawers may be kept closed without any locking system.

These configurations may not operate satisfactorily when intending to keep children away from content of cabinet and drawers. Also, during an earthquake or other events, the contents of the cabinet may fall out or drawers may slip out.

What is needed is a securing configuration that will allow the door and drawers to remain secured to the cabinet until unsecured by a user.

### SUMMARY

Provided are exemplary embodiments that may include a cabinet door and drawer securing system, including a sliding wedge, coupled to a coil spring, a shaft coupled to a cam, a knob coupled to the shaft, a clad housing with a cover. With this configuration, when the door is closed by any means, could not be opened, and the drawer if be pushed in could not be pulled out unless activated by adult.

### BRIEF DESCRIPTION OF THE DRAWINGS

FIG. 1 is a perspective view of interior of the system, unactuated position. Cover removed.

FIG. 2 is front view of the system cover.

FIG. 3 is a perspective view of a system in the actuated position. Cover removed.

FIG. 4 is a back view of system.

FIG. 5. is a perspective view of the empty clad.

FIG. 6. is a perspective view of the wedge.

FIG. 7. is a perspective view of the wedge, if used with push button.

FIG. 8. is the perspective view of the shaft nut.

FIG. 9. is the perspective view of the two levers.

FIG. 10. is the perspective view of the key-hole-cam.

FIG. 11. is the perspective view of the shaft.

FIG. 12, is the elevated view of knob and its screw.

FIG. 13. is the perspective view of the system installed on a drawer.

FIG. 14. is the perspective view of the system holding-bracket.

FIG. 15. is the perspective view of the oblique-bottom cam.

FIG. 16. is the elevated view of Push shaft pressure facility.

FIG. 17. is the perspective view of the system installed on a cabinet.

### DETAILED DESCRIPTION

The detailed description set forth below in connection with the appended drawings is intended as a description of exemplary embodiments and is not intended to represent the only forms in which the embodiments may be constructed and/or utilized.

The description also sets forth the functions and the sequence of steps for constructing and operating the invention in connection with the illustrated embodiments. However, it is to be understood that the same or equivalent functions and sequences may be accomplished by different embodiments that is also intended to be encompassed within the spirit and scope of the invention. As example instead of turning knob, a push button may be used.

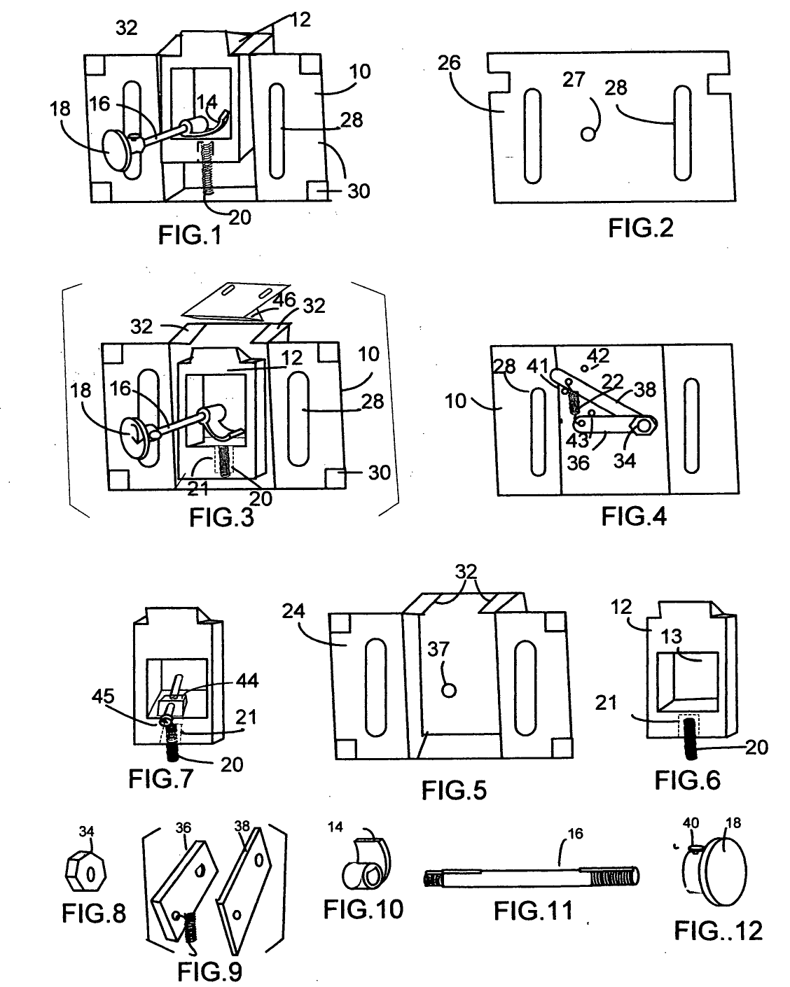

A cabinet door and drawer securing system 10, according to an exemplary embodiment is shown in FIG. 1, in an unactuated position. The cover 26, removed to show inside clad 24. The wedge 12, which has an oblique plane head on one side of its top and a straight plane in its behind. The wedge 12, has a coil-spring 20, inserted in its spring housing 21, under the wedge chamber 13. The shaft 16 passes through wedge chamber 13, and is coupled to the key-hole-cam 14, when the knob 18, which is coupled to the shaft, and tightened by its screw 40, is turned, hence the shaft and cam turns and pushes the wedge down.

FIG. 1, furthermore shows the folded corners 30, for holding the cover 24, there it shows also the two positional adjusting slotted holes 28.

FIG. 2, is the front view of cover 26 for clad 24. With the two slotted holes 28, and shaft hole 27.

FIG. 3 is the cabinet door and drawer locking system in an actuated position. The cover 26 removed, The wedge 12 has gone down, because the cam has been turned by the shaft 16, and knob 18, hence the wedge 12 has hit to the bottom, away from wedge stop-plates 32. Hence, the wedge head cannot be in the way of system holding-bracket 46 any more.

FIG. 4 is the back of the locking system 10; it is equipped with a facility, to adjust for desired knob turning tension. A turnable-lever 38, is coupled freely to the end of the shaft 16, and a key-hole-lever 36, fastened on the end of the shaft 16, tightened with nut 34. The turnable-lever 38, which is coupled to key-hole-lever 36, by a coil-spring 22, pulls up key-hole-lever 36, toward stop-pin 43, keeping the key-hole-cam toward its upright position.

Turnable-lever 38 could be positioned behind the low-pin 41, for normal users, or for higher knob turning tension, behind high-pin 42, where the knob needs more tension to be turned, which would be difficult for small children to open the lock.

FIG. 5. is prospective view of the clad 24, with slotted holes 28, folded corners 30, and shaft hole 37.

FIG. 6. is the oblique-headed wedge 12 and straight plane back, with wedge chamber 13, coil-spring 20, in its spring-housing 21.

FIG. 7. is the wedge 12, with oblique floor in its wedge chamber here instead of key-hole-cam and turnable shaft, an oblique-bottom cam 44, fitting only ⅓ length to the bottom floor, and push button 45 is been used to push in for lowering the wedge.

FIG. 8. is the elevated view of the fastening nut 34 for key-hole-lever 36.

FIG. 9. is the elevated view of the key-hole-lever 36, and turnable-lever 38.

FIG. 10. is the elevated view of the key-hole-cam 14.

FIG. 11. is the elevated view of the shaft, with key planes and threaded screw on both ends.

FIG. 12. is the elevated view of knob 18, and its tightening screw 40.

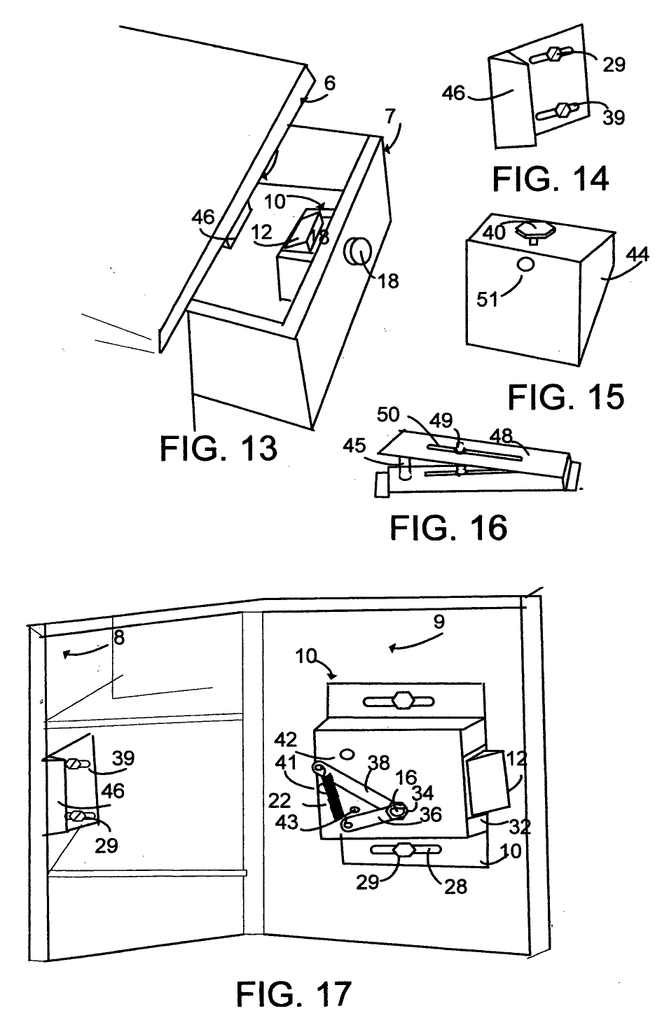

FIG. 13. is the perspective view of locking system installed on a drawer 7 for a deck or counter 6.

FIG. 14. is the elevated view of system holding-bracket 46, with its slotted holes 39 on the plate and screws 29.

FIG. 15. is the elevated view of oblique-bottom-cam 44, with its tightening screw 40 and Push shaft hole 51.

FIG. 16. is the elevated view of push shaft pressure adjusting facility, with spring plate 48, pressure adjusting screw 49, slotted-hole 50

FIG. 17. is the prospective view of, locking system installed on a cabinet door 9, with its fastening screws 29, in positionally adjusted by its slotted holes 28. Here the turnable-lever 38 is positioned behind the low-pin 41 for normal users.

In FIG. 17, on the opposite side is the system holding-bracket 46, fixed and tightened on the interior of cabinet sidewall with the positional adjusting slotted holes 39, and screws 29.

Most of the locking system parts, may be made with plastic injection, or cast from metal. The wedge may be made even from wood. The clad pressed from sheet metal, rubber, any combination thereof, or other materials, as desired. Similarly, the other portions of the system may be made from other suitable materials. It will be appreciated that other configurations and devices may be used to create the same movements and configurations, as desired.

Although screw or bolt has been shown, it will be appreciated that other fastening configurations and methods may be utilized including nails, adhesives, and other configurations and methods, as could be convenient for manufacturers or users.

This system is usable with a wide variety of existing and new cabinet systems.

As generally depicted in FIGS. 13 and 16, when the cabinet drawer 7, or door 9, is pushed to closed by a slight force, or some self-closing configuration, the wedge 12 may advance by rubbing the two oblique surfaces, one on holding-bracket 46, and the other on the wedge, 12 oblique head. The horizontal force, partly will transfer to vertical force, pushing the wedge down in the clad 24, to clear the way of holding-bracket 46, then the wedge will jump up due to the force of coil-spring 20, remaining behind holding-bracket 46 straight plane, where the door or drawer can not be pulled back and will remain locked.

Not any force can open it just by pulling the knob, and the system will remain secured unless a user, an adult or other source of force turns the knob 18, or pushes the push button 45, which lowers the wedge head, there after nothing will prevent the door or drawer from opening.

In closing it is to be understood that the exemplary embodiments described herein are illustrative of the principles of the present disclosure. Other modifications that may be employed are within the scope of the disclosure. There is no limitation; alternative configurations may be utilized in accordance with the teachings herein. Accordingly, the drawings and description are illustrative and not meant to be a limitation thereof.

What claimed is:

1. A cabinet door and drawer securing system, comprising of;
a clad, with cover having two adjusting slotted holes,
an oblique-headed wedge, sliding in said clad,
a wedge chamber, wherein said wedge, configured to have,
a coil spring, partly inserted in spring housing under the wedge chamber.

2. A rotatable shaft configured to pass through the said wedge chamber and said clad,
a key-hole-cam coupled to said shaft,
a knob behind a door or drawer is configured to be coupled and tightened by its screw to said shaft end, wherein the knob, the shaft and key-hole-cam are unactuated when the wedge is activated, and when the knob is activated the wedge too is actuated.

3. Knob turning tension facility comprising of;
a turnable-lever, loosely couple to said shaft other end behind the said clad positioning on low-pin or high-pin,
a key-hole-lever, configured to couple tight to the said shaft end,
a coil-spring coupled to said key-hole-lever and turnable-lever, pulls the said key-hole-lever to stop-pin.

4. A system holding-bracket comprises of,
an oblique-head-bracket, with a straight-back on a plate having two adjusting slotted holes.

5. The system of Clam 2, wherein said shaft comprises of;
a flat key-plane at two ends which is meanwhile treaded, configured to couple to said key-hole-cam in wedge chamber, coupled and tightened the key-hole-lever behind the clad at one end and the knob coupled behind the door or drawer at the other end,

6. The system of claim 1, configured to couple selectively positionally to cabinet door or drawer.

7. The system of claim 4, the holding-bracket, configured to couple selectively positionally to the interior of a cabinet or drawer.

8. The system of claim 6, configured to receive a horizontal force for closing, wherein this force between the wedge and holding-bracket oblique planes transfers partly to vertical force and pushes the wedge down out of holding-brackets way.

9. The system of claim 8, wherein when wedge passes the holding-bracket, stays unactuated behind the holding-bracket straight plane, keeping the door or drawer closed and securely locked.

10. The system of claim 9, a user by turning the knob could activate the wedge unlocking it and open the door or drawer.

11. A wedge chamber configured to have a oblique floor,
a push-able shaft configured to pass through the wedge chamber and the clad,
an oblique-bottom-cam coupled and tightened to said shaft,
a push-button behind the door or drawer is coupled to said shaft end.

12. The system of claim 9, a user pushing in the push-button, which has adjustable pushing pressure facility in behind, will actuate the wedge to unlock and meanwhile pulling the door handle, could open the door or drawer.
